(19) United States
(12) Patent Application Publication
(10) Pub. No.: US 2026/0280665 A1
(43) Pub. Date: Sep. 17, 2026

(54) METHOD AND APPARATUS FOR DETERMINING BEAM FOR A PERIODIC CSI-RS IN A WIRELESS COMMUNICATION SYSTEM

(71) Applicant: Google LLC, Mountain View, CA (US)

(72) Inventors: Yushu ZHANG, Beijing (CN); Jia-Hong LIOU, Taipei City (TW)

(21) Appl. No.: 19/167,552

(22) PCT Filed: Apr. 7, 2023
(86) PCT No.: PCT/CN2023/086916

§ 371 Date: Sep. 22, 2025

(51) Int. Cl. H04B 7/06; H04L 5/00

(52) U.S. Cl. CPC H04B 7/06952; H04B 7/0626; H04L 5/0048

(57) ABSTRACT

This disclosure provides systems, devices, apparatus, and methods, including computer programs encoded on storage media, for a UE to determine a default beam to receive an aperiodic reference signal (e.g., CSI-RS). The UE may determine the default beam before the UE finishes decoding a scheduling or triggering signal for the aperiodic reference signal when determining a transmission configuration indicator (TCI) state associated with the aperiodic reference signal. A UE (102) receives (404), from a network entity (104), a configuration for a plurality of TCI states. The UE (102) receives (410), from the network entity (104), an indication for scheduling or triggering an aperiodic reference signal associated with one of the plurality of TCI states. The UE (102) receives (412), from the network entity (104), the aperiodic reference signal using a default beam. The default beam is selected based on a timing of the aperiodic reference signal being below a threshold.

### TECHNICAL FIELD

The present disclosure relates generally to wireless communication, and more particularly, to techniques for a user equipment (UE) to determine one or more default beams to receive an aperiodic channel state information reference signal (CSI-RS) before the UE decodes a scheduling signal for the aperiodic CSI-RS when determining a transmission configuration indicator (TCI) state associated with the aperiodic CSI-RS.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a 5G-RAN may transmit a channel state information reference signal (CSI-RS) for UEs to measure characteristics of the radio channels. TCI information associated with the CSI-RS may indicate to the UEs how to receive a transmission beam carrying the CSI-RS. However, mechanisms for UEs to measure and report the measurements aided by the TCI information is often inefficient, resulting in lower system performance.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, may transmit, to a user equipment (UE), reference signals (e.g., synchronization signal block (SSB), channel state information reference signal (CSI-RS), sounding reference signal (SRS), etc.) for the UE to measure and report radio channel characteristics, to identify best directional beams for beam management, etc. The base station may configure and transmit a set of Transmission Configuration Indicator (TCI) states to specify a quasi co-location (QCL) relationship between the reference signals and downlink (DL) channels or spatial transmission (Tx) parameters for uplink (UL) channels so that the UE may use the channel characteristics estimated from the reference signals to receive DL transmissions or the spatial Tx parameters to transmit UL transmissions. A unified TCI framework may streamline beam indication for a single transmission/reception point (S-TRP). Under this framework, one joint TCI state may apply to most of the DL/UL channels and a reference signal such as CSI-RS, one DL TCI state may apply to most of the DL channels and a reference signal, or one UL TCI state may apply to most of the UL channels and a reference signal. The unified TCI framework may be extended to multiple TRP (M-TRP). For example, a TCI field may indicate two unified TCIs (one corresponding to a 1st TRP, and the other one to a 2nd TRP).

The base station may transmit downlink control information (DCI) on a physical downlink control channel (PDCCH) to schedule or trigger the UE to receive an aperiodic CSI-RS. The base station may then transmit the aperiodic CSI-RS after an offset from the scheduling or triggering DCI. There is an inherent delay for the UE to properly decode the received scheduling or triggering DCI to understand which TCI applies to the aperiodic CSI-RS, and to switch a receiving beam to receive the aperiodic CSI-RS. However, if this delay is larger than the offset between the scheduling or triggering DCI and the aperiodic CSI-RS, the UE may not be able to determine the TCI applied to the aperiodic CSI-RS in time for the UE to adjust the receiving beam before the aperiodic CSI-RS arrives.

Aspects of the present disclosure address how the UE may determine a default beam for receiving or buffering the aperiodic CSI-RS under the unified TCI framework. That is, the UE may determine which indicated TCI state or QCL assumption to use for determining the default beam to receive and buffer the aperiodic CSI-RS before the UE decodes the scheduling or triggering DCI for aperiodic CSI-RS. Aspects of the present disclosure include a multiple DCI (M-DCI) mode where the base station may transmit multiple DCI messages to apply more than one TCI state to the aperiodic CSI-RS where each of the more than one TCI state is associated with a different TRP or different CORESETPoolIndex value or different TRP identifier. Aspects of the present disclosure may also include a single DCI (S-DCI) mode where the base station may transmit a single DCI message to apply more than one TCI state to the aperiodic CSI-RS where each of the more than one TCI state is associated with a different TRP or different CORESETPoolIndex value or different TRP identifier.

According to some aspects, a UE receives, from a network entity, a configuration for a plurality of transmission configuration indicator (TCI) states. The UE receives, from the network entity, an indication for scheduling/triggering an aperiodic reference signal associated with one of the plurality of TCI states. The UE receives, from the network entity, the aperiodic reference signal using a default beam. The default beam is selected based on a timing of the aperiodic reference signal being below a threshold.

According to some aspects, a network entity transmits, to a UE, a configuration for a plurality of transmission configuration indicator (TCI) states. The network entity transmits, to the UE, an indication for scheduling/triggering an aperiodic reference signal associated with one of the plurality of TCI states. The network entity transmits, to the UE, the aperiodic reference signal for the UE to receive using a default beam. The default beam is selected based on a timing of the aperiodic reference signal being below a threshold.

### BRIEF DESCRIPTION OF THE DRAWINGS

FIG. 1 illustrates a diagram of a wireless communications system that includes a plurality of user equipment (UEs) and network entities in communication over one or more cells.

FIG. 2 is a diagram illustrating that a UE is not able to decode the signaling that schedules the aperiodic CSI-RS to switch a receiving beam to receive the aperiodic CSI-RS before the arrival of the aperiodic CSI-RS.

FIG. 3 is a signaling diagram illustrating communications between a user equipment (UE) and a network entity for the UE to determine one or more default beams to receive an aperiodic CSI-RS.

FIG. 4 is a flowchart of a method of wireless communication at a UE.

FIG. 5 is a flowchart of a method of wireless communication at a network entity.

FIG. 6 is a diagram illustrating a hardware implementation for an example UE apparatus.

FIG. 7 is a diagram illustrating a hardware implementation for one or more example network entities.

### DETAILED DESCRIPTION

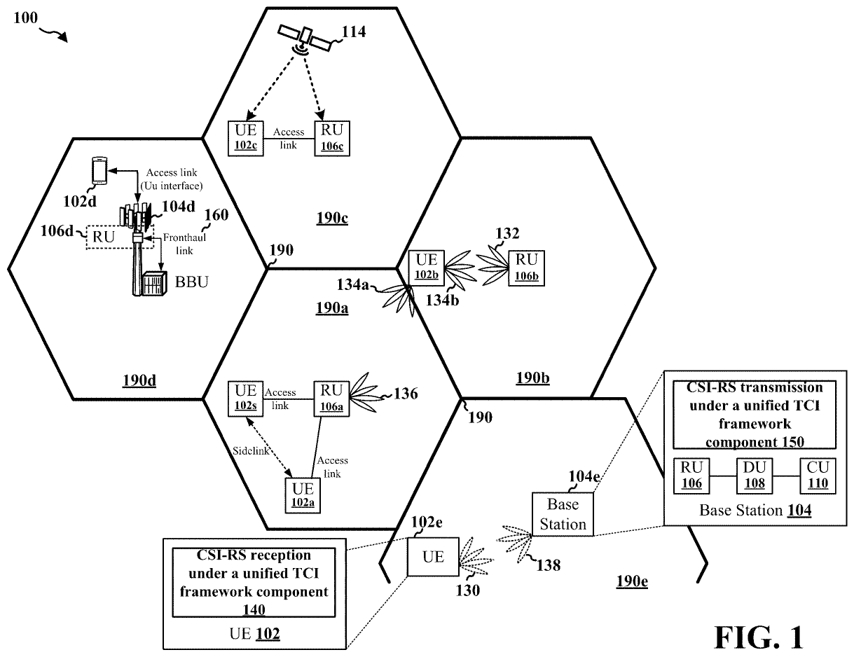

FIG. 1 illustrates a diagram 100 of a wireless communications system associated with a plurality of cells 190. The wireless communications system includes user equipment (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102 d and the base station 104d/RU 106 d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR 2). FR1 ranges from 410 MHz-7.125 GHz and FR2 ranges from 24.25 GHZ-71.0 GHz, which includes FR2-1 (24.25 GHz-52.6 GHZ) and FR2-2 (52.6 GHZ-71.0 GHZ). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHZ-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHZ. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHZ-71.0 GHZ, FR 4, which ranges from 71.0 GHz-114.25 GHz, and FR 5, which ranges from 114.25 GHZ-300 GHz. The upper limit of FR 5 corresponds to the upper limit of the EHF band. Thus, unless otherwise specifically stated herein, the term “sub-6 GHZ” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 may or may not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104 e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a CSI-RS reception under a unified transmission configuration indicator (TCI) framework component 140 (also referred to as “CSI-RS reception component 140”) configured to receive from any of the base station/network entity 104 a plurality of TCI states. The CSI-RS reception component 140 may receive from the base station/network entity 104 an indication for scheduling or triggering an aperiodic reference signal associated with one of the plurality of TCI states. The CSI-RS reception component 140 may receive from the base station/network entity 104 the aperiodic reference signal using a default beam. The CSI-RS reception component 140 may select the default beam based on a timing of the aperiodic reference signal being below a threshold.

In certain aspects, any of the base stations 104 or a network entity of the base stations 104 may include a CSI-RS transmission under a unified transmission configuration indicator (TCI) framework component 150 (also referred to as “CSI-RS transmission component 150”) configured to transmit to any of the UEs 102 a plurality of TCI states. The CSI-RS transmission component 150 may transmit to any of the UEs 102 an indication for scheduling or triggering an aperiodic reference signal associated with one of the plurality of TCI states. The CSI-RS transmission component 150 may transmit to any of the UEs 102 the aperiodic reference signal for any of the UEs 102 to receive using a default beam. The default beam may be selected based on a timing of the aperiodic reference signal being below a threshold.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

As mentioned, a base station 104 may configure and transmit a set of TCI states to specify a QCL relationship between a reference (e.g., an aperiodic CSI-RS) and DL channels or UL channels so that the UE may use the channel characteristics estimated from the reference signal to receive DL transmissions or transmit UL transmissions. A unified TCI framework may streamline beam indication and reduce latency of beam indication for a single TRP (S-TRP). Under this framework, one joint TCI state may apply to most of the DL/UL channels and a reference signal such as CSI-RS, one DL TCI state may apply to most of the DL channels and a reference signal, or one UL TCI state may apply to most of the UL channels and a reference signal. The unified TCI framework may be extended to multiple TRP (M-TRP). For example, a TCI field may indicate two unified TCIs (one corresponding to a 1^{st} TRP, and the other one to a 2^{nd} TRP).

A UE 102 may apply an indicated TCI state to determine a transmission beam of the reference signal and to adjust its receiving parameters to receive the reference signal. In the unified TCI framework, the base station 104 may transmit a scheduling or triggering signaling to the UE 102 to schedule the UE 102 to receive an aperiodic CSI-RS. The UE 102 may decode the scheduling or triggering signaling to understand which TCI applies to the aperiodic CSI-RS, and to switch a receiving beam to receive the aperiodic CSI-RS. However, due to decoding latency, the UE 102 may not be able to decode the scheduling or triggering signaling to determine the TCI applied to aperiodic CSI-RS before the UE 102 receives the aperiodic CSI-RS.

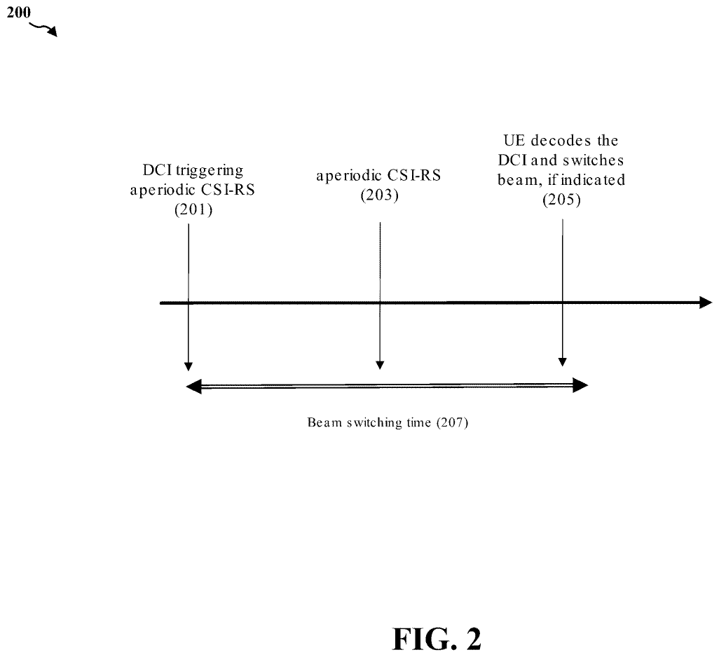

FIG. 2 is a diagram illustrating that a UE 102 is not able to decode the signaling that schedules the aperiodic CSI-RS to switch a receiving beam to receive the aperiodic CSI-RS before the arrival of the aperiodic CSI-RS.

The UE 102 may receive 201 a scheduling or triggering signaling such as a DCI on a physical downlink control channel (PDCCH) from the network entity 104. The DCI may schedule transmission of an aperiodic CSI-RS.

The UE 102 may decode 205 the DCI to determine which TCI applies to the aperiodic CSI-RS and may switch its receiving beam (UE receive beam) to receive the aperiodic CSI-RS. A beam switching time 207 may include the latency associated with decoding the DCI and with adjusting the receiving parameters. If the beam switching time 207 is larger than an offset between the DCI and the scheduled aperiodic CSI-RS, the UE 102 may not be able to switch its receiving beam in time when the aperiodic CSI-RS arrives 203.

Aspects of the present disclosure address how the UE 102 may determine a default beam for receiving/buffering the aperiodic CSI-RS under the unified TCI framework. That is, the UE 102 may determine which indicated TCI state or QCL assumption to use for determining the default beam to receive and buffer the aperiodic CSI-RS before the UE decodes the scheduling or triggering DCI for aperiodic CSI-RS. The UE 102 may select a default beam when a timing of the aperiodic CSI-RS is below a threshold. In one implementation, the timing of the aperiodic CSI-RS may include a timing offset between the transmission (or reception) of the DCI and the transmission (or reception) of the aperiodic CSI-RS. The threshold may be the beam switching time 207 of the UE 102. Aspects of the present disclosure include a M-DCI mode where the base station may transmit multiple DCI messages to apply more than one TCI state to the aperiodic CSI-RS where each of the more than one TCI state is associated with a different TRP or different CORESETPoolIndex value or different TRP identifier. Aspects of the present disclosure may also include a S-DCI mode where the base station may transmit a single DCI message to apply more than one TCI state to the aperiodic CSI-RS where each of the more than one TCI state is associated with a different TRP or different CORESETPoolIndex value or different TRP identifier.

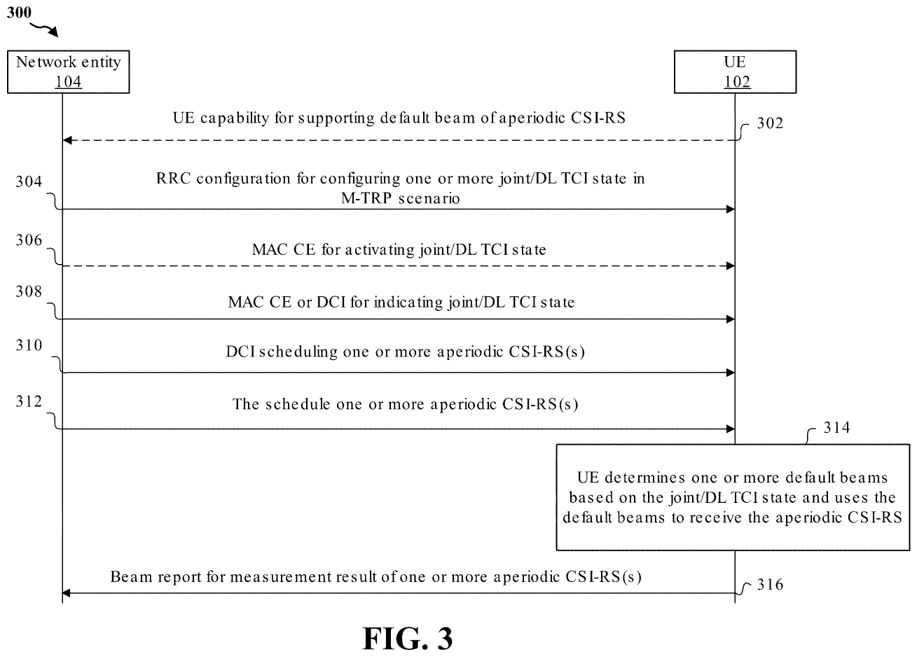

FIG. 3 is a signaling diagram 300 illustrating communications between a user equipment (UE) 102 and a network entity 104 for the UE 102 to determine one or more default beams to receive an aperiodic CSI-RS.

The UE 102 may transmit 302, to the network entity 104, information on capabilities of the UE 102 to support using a default beam to receive an aperiodic CSI-RS. In one implementation, the UE 102 may support using a default beam when a timing of the aperiodic CSI-RS is below a threshold. In some implementations, the UE 102 may report the beam switching time (e.g., beam switching time 207 of FIG. 2) in the parameter beamSwitchTiming when the UE 102 transmits its capability information to the network entity 104.

Based on the received capability information of the UE 102, the network entity 104 may transmit 304, to the UE 102, a Radio Resource Control (RRC) signaling to configure one or more joint or downlink (DL) TCI state in a M-TRP scenario. In one implementation, the network entity 104 may transmit the RRC signaling to configure a M-TRP scenario.

In some implementations, the network entity 104 may configure one or more TCI state lists for a component carrier (CC) of a serving cell, where the CC may be PCell or SCell. For example, the network entity 104 may configure a joint TCI state list for a CC of a serving cell, and/or configure a DL TCI state list and/or a UL TCI state list for a CC of a serving cell. One joint TCI state list may include one or more joint TCI states; one DL TCI state list may include one or more DL TCI states; and one UL TCI state list may include one or more UL TCI states.

In some implementations, the network entity 104 may configure a RRC parameter unifiedTCI-StateType. The RRC parameter unifiedTCI-StateType may be a per-serving-cell configuration. The RRC parameter unifiedTCI-StateType may indicate the type of TCI state list(s) for a serving cell. For example, the RRC parameter unifiedTCI-StateType may indicate “joint” or “separate”. If the first RRC parameter for a CC of serving cell indicates “joint”, the network entity 104 may explicitly or implicitly configure the UE 102 to indicate one or more joint TCI state list(s) for the CC of serving cell. If the first RRC parameter for a CC of serving cell indicates “separate”, the network entity 104 may explicitly or implicitly configure the UE 102 to indicate one or more DL TCI state list(s) or UL TCI state list(s) for the CC of serving cell.

The network entity 104 may transmit 306, to the UE 102, an activation signaling to activate the one or more joint or DL TCI state. In one implementation, the network entity 104 may transmit a media access control (MAC) control element (MAC-CE) to activate the one or more joint or DL TCI state.

In some implementations, the MAC-CE may activate or indicate one or more TCI states from the one or more TCI state list(s). The one or more TCI states activated/indicated by the MAC-CE may map to one or more TCI codepoints in a TCI field. In some implementations, if the number of TCI states activated/indicated by the first MAC-CE is two, and/or if the two TCI states are associated with different TRP identifier or applicable for different TRP, the UE 102 may apply or use these the two TCI states activated/indicated by the MAC-CE for performing corresponding subsequent DL and/or UL transmission.

In some implementations, one TCI state may map to one TCI codepoint. In some implementations, more than one TCI states may map to one TCI codepoint. In some implementations, the TCI codepoint may indicate one or more joint TCI states, one or more DL TCI states, one or more UL TCI states, or one or more DL TCI states and one or more UL TCI states. In these cases, some of the TCI states may be TCI states associated with a first TRP and the other may be TCI states associated with a second TRP.

The network entity 104 may transmit 308, to the UE 102, an indication signaling to indicate a joint or DL TCI state to be applied. In one implementation, the network entity 104 may transmit a DCI on PDCCH to indicate a joint or DL TCI state to specify a QCL relationship between the aperiodic CSI-RS and Physical Downlink Shared Channel (PDSCH). In one implementation, the network entity 104 may transmit a MAC-CE to indicate a joint or DL TCI state to specify a QCL relationship between the aperiodic CSI-RS and PDCCH.

In some implementations, the indication signaling may indicate a first indicated TCI state and a second indicated TCI state. In some implementations, the first indicated TCI state may be an indicated TCI state associated with a first TRP identifier (e.g., CORESETPoolIndex #0) and the second indicated TCI state may be an indicated TCI associated with a second TRP identifier (e.g., CORESETPoolIndex #1). In some implementations, the first indicated TCI may be an indicated TCI activated in a first or earlier order and the second indicted TCI may be an indicated TCI activated in a second or later order when an indicated TCI pair maps to a TCI field codepoint.

The network entity 104 may transmit 310, to the UE 102, a scheduling or triggering signaling to schedule transmission of one or more aperiodic CSI-RS. In one implementation, the network entity 104 may transmit a DCI to trigger the transmission of one or more aperiodic CSI-RS using scheduled resources that are offset in time from the DCI.

The network entity 104 may transmit 312, to the UE 102, the one or more aperiodic CSI-RS at the scheduled time.

The UE 102 may decode 314 the scheduling or triggering signaling (e.g., DCI) that triggers the transmission of the aperiodic CSI-RS to understand which TCI state of the indicated joint/DL TCI state applies to the aperiodic CSI-RS, and to switch a receiving beam to receive the aperiodic CSI-RS. In one implementation, the UE 102 may determine one or more default beams to use to receive the aperiodic CSI-RS when a timing of the aperiodic CSI-RS is below a threshold. For example, the UE 102 may determine one or more default beams based on the indicated joint/DL TCI state when the offset from the scheduling or triggering DCI is less than the beam switching time (e.g., beam switching time 207 of FIG. 2) of the UE 102. Thus, the UE 102 may determine one or more default beams to receive the aperiodic CSI-RS before the UE 102 successfully decodes the DCI and completes beam switching. The UE may measure the aperiodic CSI-RS to generate measurement information.

The UE 102 may transmit 316, to the network entity 104, a beam report containing the measurement information for the aperiodic CSI-RS. In one implementation, the network entity may adjust DL and/or UL transmission beams based on the beam report.

Following is a detailed discussion of how the UE 102 may determine a default beam for receiving the aperiodic CSI-RS under the unified TCI framework for M-TRP.

In some implementations, a TRP may be associated with or identified by a TRP identifier. In some implementations, a network entity 104 may include or configure TRP identifier in UL configuration(s) that the network entity 104 transmits to a UE 102 for UL transmission(s) via a TRP identified by the TRP identifier. In some implementations, the network entity 104 may include a TRP identifier in DL configuration(s) that the network entity 104 transmits to the UE 102 for DL transmission(s) via a TRP identified by the TRP identifier.

In some implementations, the network entity 104 does not transmit/configure a TRP identifier to the UE 102 and may use an implicit indication to indicating a TRP to the UE 102. In some implementations, the implicit indication can be one of the following configuration parameters: a CORESETPoolIndex, a value (candidate) of a CORESETPoolIndex, dataScramblingIdentityPDSCH, dataScramblingIdentityPDSCH2-r16, or PUCCH-ResourceGroup-r16. The UE 102 may derive a TRP identifier from the implicit indication.

In some implementations, the network entity 104 may indicate that a serving cell is associated with a first TRP (or a first TRP identifier) and that a non-serving cell is associated with a second TRP (or a second TRP identifier). In some implementations, the network entity 104 may configure a separate control resource set (CORESET) to be associated with the first TRP and the second TRP. For example, the network entity 104 may configure CORESETPoolIndex #0 to identify the first CORESET and configure CORESETPoolIndex #1 to identify the second CORESET. The UE 102 may monitor a PDCCH on the first CORESET from the first TRP or the second CORESET from the second TRP to determine that CORESETPoolIndex #0 indicates the first TRP of the serving cell and that CORESETPoolIndex #1 indicates the second TRP of the non-serving cell, respectively.

In some implementations, in a M-DCI scenario where the network entity 104 transmits multiple DCI messages to apply more than one TCI state, the network entity 104 may configure the UE 102 to determine two default beams on a symbol within a slot. The UE 102 may determine two default beams for receiving or buffering one or more aperiodic CSI-RS(s). The UE 102 may receive or buffer the one or more aperiodic CSI-RS(s), before the UE 102 decodes a DCI triggering the one or more aperiodic CSI-RS(s) successfully. In some scenarios, the UE 102 may determine that there is no aperiodic CSI-RS transmitted from the network entity 104 via the determined first default beam or the second default beam on the symbol of the slot. In some scenarios, the UE 102 may determine that there is no aperiodic CSI-RS transmitted from the network entity 104 if the UE 102 could not detect any DCI for scheduling/triggering aperiodic CSI-RS in the slot.

In some implementations, the first default beam may be associated with a first TRP identifier. The second default beam may be associated with a second TRP identifier. In some implementations, the UE 102 may use the first default beam for receiving or buffering one or more aperiodic CSI-RS(s) associated with the first TRP identifier on the symbol. In some implementations, the UE may use the second default beam for receiving or buffering one or more aperiodic CSI-RS(s) associated with the second TRP identifier on the symbol.

In some implementations, the UE 102 may determine the first default beam and the second default beam based on whether there is a DL signal associated with the first TRP identifier or the second TRP identifier, where the DL signal is transmitted or scheduled on the same symbol as the aperiodic CSI-RS. In some implementations, the DL signal may include SSB, SSB for beam measurement or layer 1 reference signal received power (L1-RSRP) or layer 1 signal to interference plus noise ratio (L1-SINR) measurement/report, SSB for beam failure detection (BFD), SSB for candidate beam detection for beam failure recovery (BFR), SSB for radio link monitoring (RLM), SSB as a QCL source RS in an activated TCI for the UE, periodic CSI-RS, semi-persistent CSI-RS, other aperiodic CSI-RS with scheduling or triggering offset larger than or equal to a threshold or value reported in a UE capability (e.g., beamSwitchTiming), PDCCH or a CORESET or a search space, PDSCH with scheduling or triggering offset larger than or equal to a threshold time (e.g., timeDurationForQCL).

In some implementations, if there is a DL signal associated with the first TRP identifier, where the DL signal is transmitted or scheduled on the same symbol as the aperiodic CSI-RS, the UE 102 may determine the first default beam uses the indicated TCI state applied for the DL signal associated with the first TRP identifier. Analogously, if there is a DL signal associated with the second TRP identifier, where the DL signal is transmitted or scheduled on the same symbol as the aperiodic CSI-RS, the UE 102 may determine the second default beam uses the indicated TCI state applied for the DL signal associated with the second TRP identifier. In some implementations, the UE 102 may receive the configuration to associate a TRP identifier with a DL signal from the network entity 104 by RRC signaling, MAC-CE, or DCI.

In some implementations, if there is no DL signal associated with the first TRP identifier, where the DL signal is transmitted or scheduled on the same symbol as the aperiodic CSI-RS, the UE 102 may determine the first default beam uses the first indicated TCI. Analogously, if there is no DL signal associated with the second TRP identifier, where the DL signal is transmitted or scheduled on the same symbol as the aperiodic CSI-RS, the UE 102 may determine the second default beam uses the second indicated TCI.

In some implementations, if the first default beam of the second default beam is associated with an additional physical channel identity (PCI), the UE 102 may not use the beam. The additional PCI may correspond to a neighboring cell or non-serving cell in proximity of the physical serving cell of the UE 102. If a CORESET, a TCI state, or a RRC configuration is associated with or includes an additional PCI, it may imply that the CORESET, TCI state, or RRC configuration is associated with, applied for, or transmitted from a neighboring cell or non-serving cell corresponding to the additional PCI.

If the first default beam is associated with an additional PCI, the UE 102 may instead apply an indicated TCI for receiving a special CORESET associated with the first TRP identifier. In some implementations, the special CORESET associated with the first TRP identifier may be a CORESET with the lowest CORESET-ID among CORESETs associated with the first TRP identifier, where the CORSETs are monitored in a latest slot, in the active BWP, or in the service cell/CC. This may apply when the UE 102 receives or buffers the one or more aperiodic CSI-RS(s) in PCell.

Analogously, if the second default beam is associated with an additional PCI, the UE 102 may instead apply an indicated TCI for receiving a special CORESET associated with the second TRP identifier. In some implementations, the special CORESET associated with the second TRP identifier may be a CORESET with the lowest CORESET-ID among CORESETs associated with the second TRP identifier, where the CORSETs are monitored in a latest slot, in the active BWP, or in the service cell/CC. This may apply when the UE 102 receives or buffers the one or more aperiodic CSI-RS(s) in PCell.

In some implementations, in a cross-carrier scheduling scenario, when the UE 102 determines one or more joint or DL TCI state(s) for receiving or buffering the aperiodic CSI-RS, the UE 102 may determine one or more indicated TCI state(s) or QCL assumption(s) to receive or buffer the aperiodic CSI-RS in the serving cell or CC. That is, the UE 102 may not consider indicated TCI states(s) or QCL assumptions in the scheduling cell or CC.

In some implementations, in a M-DCI scenario, if the network entity 104 does not configure the UE 102 to determine two default beams on a symbol within a slot, the UE 102 may determine one default beam for receiving or buffering one or more aperiodic CSI-RS(s). In some implementations, the single default beam may be associated with any TRP identifier on the symbol.

In some implementations, the UE 102 may determine the single default beam based on whether there is a DL signal transmitted or scheduled on the symbol. The DL signal may include the same types of signals the UE 102 considers when determining two default beams as discussed.

In some implementations, if there is a DL signal associated with the first TRP identifier or the second identifier, where the DL signal is transmitted on the same symbol as the aperiodic CSI-RS, the UE 102 may determine the single default beam uses the indicated TCI state applied for the DL signal associated with the first TRP identifier or the second TRP identifier.

In some implementations, if there is no DL signal transmitted or scheduled on the symbols, the UE 102 may determine the default beam uses the first indicated TCI state or the second indicated TCI state.

In some implementations, if there is no DL signal transmitted or scheduled on the symbols, the UE 102 may determine a different default beam for receiving or buffering the one or more aperiodic CSI-RS(s), according to the index of the symbol and/or the slot. For example, if the slot index is even, the UE 102 may determine the default beam uses the first indicated TCI. If the slot index is odd, the UE 102 may determine the default beam uses the second indicated TCI. The UE 102 may similarly determine a different default beam based on symbol index.

In some implementations, if there is no DL signal transmitted or scheduled on the symbols, the UE 102 may determine the default beam based on a RRC signal configured by the network entity 104. In some implementations, the RRC signal may indicate/configure the UE 102 to use the first indicated TCI state or the second TCI state as the default beam. In some cases, the RRC signal may indicate/configure the UE 102 to use an another indicated TCI state or quasi-co-location assumption, other than the first or second indicated TCI state, as the default beam. In such cases, the another indicated TCI state or quasi-co-location assumption may be applied for receiving and/or transmitting a non-UE-specific or special channel/RS, e.g., CORESET #0.

In some implementations, if there is no DL signal transmitted or scheduled on the symbols, the UE 102 may determine the default beam(s) use both the first and the second indicated TCI states. In some implementations, when the UE 102 detects or decodes successfully a DCI triggering the one or more aperiodic CSI-RS(s), the DCI triggering the one or more aperiodic CSI-RS(s) may indicate which indicated TCI states is used to transmit the one or more aperiodic CSI-RS(s). In some implementations, the DCI triggering the one or more aperiodic CSI-RS(s) may indicate such information via a DCI field or an aperiodic CSI-RS triggering state that is associated with information of the indicated TCI state(s). In some implementations, the DCI triggering the one or more aperiodic CSI-RS(s) nay indicate such information implicitly (e.g., by CORESETPoolIndex value of the CORESET scheduling the DCI, where CORESETPoolIndex #0 means the first (or second) indicated TCI is used to transmit the one or more aperiodic CSI-RS(s) and CORESETPoolIndex #1 means the second (or first) indicated TCI is used to transmit the one or more aperiodic CSI-RS(s)).

In some implementations, if there is no DL signal transmitted or scheduled on the symbols, the UE 102 may determine the single default beam using the same techniques, described herein, for determining the first default beam or the second default beam in the scenario of the two default beams when there is no DL signal associated with the first TRP identifier or the second TRP identifier.

In some implementations, in a S-DCI scenario where the network entity 104 transmits a single DCI message to apply more than one TCI state, the UE 102 may determine one or more joint/DL TCI state(s) or quasi-co-location assumption(s) for receiving or buffering one or more aperiodic CSI-RS(s) based on whether a single frequency network (SFN) is configured for PDCCH or PDSCH.

In some implementations, if an SFN-PDCCH or an SFN-PDSCH is not configured, the UE 102 may determine the default beam using the same techniques, described herein, for determining the single default beam in the M-DCI scenario.

In some implementations, if an SFN-PDCCH or an SFN-PDSCH is configured, and there is no DL signal transmitted or scheduled on the same symbols as the aperiodic CSI-RS, UE 102 may use both the first and the second indicated TCI states to receive or buffer the aperiodic CSI-RS. In some implementations, even if an SFN-PDCCH or an SFN-PDSCH is configured, the UE 102 may determine the default beam using the same techniques, described herein, for determining the default beam in the non SFN-PDCCH or SFN-PDSCH.

In one aspect, the UE 102 may determine one or more beams for receiving the aperiodic CSI-RS even when the UE 102 is able to successfully decode the scheduling DCI for the aperiodic CSI-RS and to switch a beam when the CSI-RS is received (e.g., when the offset between the scheduling/triggering DCI and the aperiodic CSI-RS is larger than the beam switching time 207 of FIG. 2. This scenario may arise when the network entity 104 does not specify a QCL relationship for a resource set of aperiodic CSI-RS.

In some implementations, in a M-DCI or S-DCI scenario when QCL information is absent for an aperiodic CSI-RS resource set, the network entity 104 may configure a RRC signaling to indicate the UE 102 to apply a first TCI state or a second TCI state for the aperiodic CSI-RS resource set. The RRC signaling may indicate or include a CORESETPoolIndex value. For example, CORESETPoolIndex index #0 may imply the first indicated TCI state, and CORESETPoolIndex index #1 may imply the second indicated TCI, or vice versa.

In some implementations, when QCL information is absent for an aperiodic CSI-RS resource set, and the network entity 104 does not configure a RRC signaling to indicate the TCI state to apply for the CSI-RS resource set, the UE 102 may determine which TCI state or quasi-co-location assumption to use to receive an CSI-RS in the aperiodic CSI-RS resource set. The UE 102 may make such determination using the same technique, as described herein, for determining a default beam when the UE 102 cannot decode the scheduling DCI before the aperiodic CSI-RS is received in the M-DCI or S-DCI scenario. For example, the UE 102 may apply the indicated TCI state used for a DL signal on the same symbol as the aperiodic CSI-RS. Alternatively, the UE 102 may make such determination based on the indicated TCI state associated with a specific CORESETPoolIndex value, such as the CORESETPoolIndex value of the CORESET that carries or transmits the scheduling DCI triggering the aperiodic CSI-RS resource set.

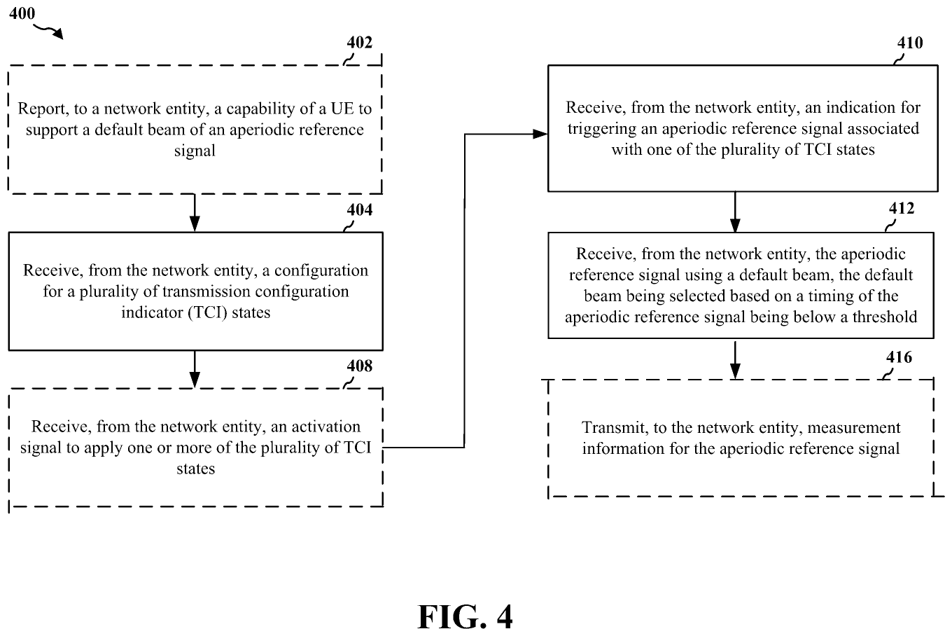

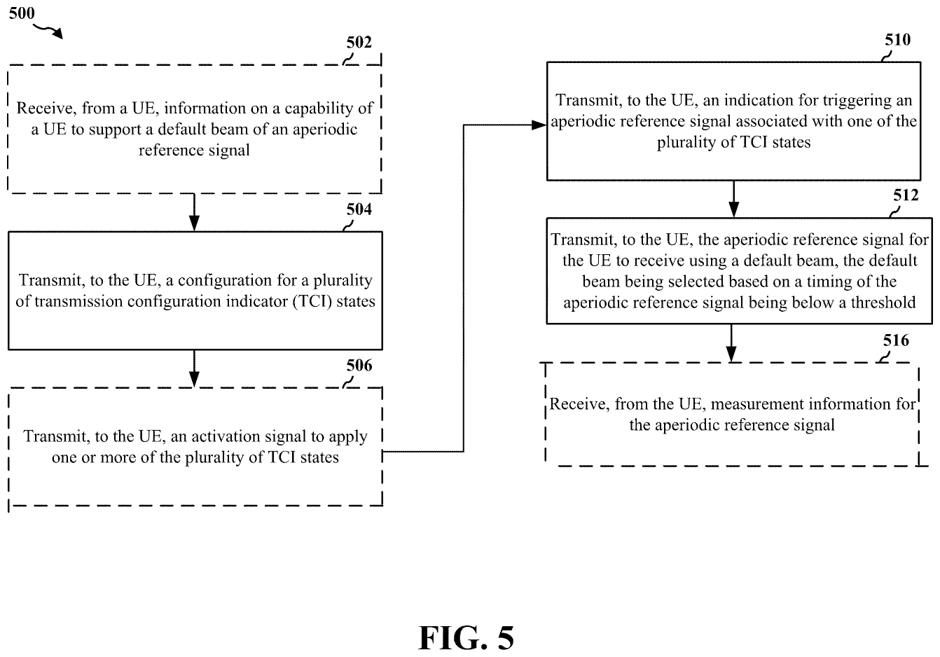

FIGS. 4-5 show methods for implementing one or more aspects of FIGS. 2-3. In particular, FIG. 4 shows an implementation by the UE 102 of the one or more aspects of FIGS. 2-3. FIG. 5 shows an implementation by the network entity 104 of the one or more aspects of FIGS. 2-3.

FIG. 4 is a flowchart of a method 400 of wireless communication at a UE. With reference to FIGS. 1, 3 and 6, the method may be performed by the UE 102, the UE apparatus 602, etc., which may include the memory 626′, 606′, 616, and which may correspond to the entire UE 102 or the entire UE apparatus 602, or a component of the UE 102 or the UE apparatus 602, such as the wireless baseband processor 626 and/or the application processor 606.

The UE reports 402, to a network entity, a capability of a UE to support a default beam of an aperiodic reference signal. For example, referring to FIG. 3, the UE 102 transmits 302, to the network entity 104, information on capabilities of the UE 102 to support using a default beam to receive an aperiodic CSI-RS. In one implementation, the UE 102 may support using a default beam when a timing of the aperiodic CSI-RS is below a threshold. In some implementations, the UE 102 may report the beam switching time 207 in the parameter beamSwitchTiming when the UE 102 transmits its capability information to the network entity 104.

The UE receives 404, from the network entity, a configuration for a plurality of TCI states. For example, referring to FIG. 3, the network entity 104 transmits 304, to the UE 102, a RRC signaling to configure one or more joint or DL TCI state in a M-TRP scenario. In one implementation, the network entity 104 may transmit the RRC signaling to configure a M-TRP scenario.

The UE receives 408, from the network entity, an activation signal to apply one or more of the plurality of TCI states. For example, referring to FIG. 3, the network entity 104 transmits 308, to the UE 102, an indication signaling to indicate a joint or DL TCI state to be applied. In one implementation, the network entity 104 may transmit a DCI on PDCCH to indicate a joint or DL TCI state to specify a QCL relationship between the aperiodic CSI-RS and PDSCH. In one implementation, the network entity 104 may transmit a MAC-CE to indicate a joint or DL TCI state to specify a QCL relationship between the aperiodic CSI-RS and PDCCH.

The UE receives 410, from the network entity, an indication for triggering an aperiodic reference signal associated with one of the plurality of TCI states. For example, referring to FIG. 3, the network entity 104 transmits 310, to the UE 102, a scheduling or triggering signaling to schedule transmission of one or more aperiodic CSI-RS. In one implementation, the network entity 104 may transmit a DCI to trigger the transmission of one or more aperiodic CSI-RS using scheduled resources that are offset in time from the DCI.

The UE receives 412, from the network entity, the aperiodic reference signal using a default beam, the default beam being selected based on a timing of the aperiodic reference signal being below a threshold. For example, referring to FIG. 3, the network entity 104 transmits 312, to the UE 102, the one or more aperiodic CSI-RS at the scheduled time. The UE 102 may determine one or more default beams to use to receive the aperiodic CSI-RS when a timing of the aperiodic CSI-RS is below a threshold. For example, the UE 102 may determine one or more default beams based on the indicated joint/DL state when the offset from the scheduling or triggering DCI is less than the beam switching time (e.g., beam switching time 207 of FIG. 2) of the UE 102. Thus, the UE 102 may determine one or more default beams to receive the aperiodic CSI-RS before the UE 102 successfully decodes the DCI and completes beam switching.

The UE transmits 416, to the network entity, measurement information for the aperiodic reference signal. For example, referring to FIG. 3, the UE 102 transmit 316, to the network entity 104, a beam report containing the measurement information for the aperiodic CSI-RS.

FIG. 5 is a flowchart 500 of a method of wireless communication at a network entity. With reference to FIGS. 1, 3, and 7, the method may be performed by one or more network entities 104, which may correspond to a base station or a unit of the base station, such as the RU 106, the DU 108, the CU 110, an RU processor 706, a DU processor 726, a CU processor 746, etc. The one or more network entities 104 may include memory 706′, 726′, and 746′, and may correspond to an entirety of the one or more network entities 104, or a component of the one or more network entities 104, such as the RU processor 706, the DU processor 726, or the CU processor 746

The network entity receives 502, from a UE, information on a capability of a UE to support a default beam of an aperiodic reference signal. For example, referring to FIG. 3, the UE 102 transmits 302, to the network entity 104, information on capabilities of the UE 102 to support using a default beam to receive an aperiodic CSI-RS. In one implementation, the UE 102 may support using a default beam when a timing of the aperiodic CSI-RS is below a threshold. In some implementations, the UE 102 may report the beam switching time (e.g., beam switching time 207 of FIG. 2) in the parameter beamSwitchTiming when the UE 102 transmits its capability information to the network entity 104.

The network entity transmits 504, to the UE, a configuration for a plurality of TCI states. For example, referring to FIG. 3, the network entity 104 transmits 304, to the UE 102, a RRC signaling to configure one or more joint or DL TCI state in a M-TRP scenario. In one implementation, the network entity 104 may transmit the RRC signaling to configure a M-TRP scenario.

The network entity transmits 508, to the UE, an activation signal to apply one or more of the plurality of TCI states. For example, referring to FIG. 3, the network entity 104 transmits 308, to the UE 102, an indication signaling to indicate a joint or DL TCI state to be applied. In one implementation, the network entity 104 may transmit a DCI on PDCCH to indicate a joint or DL TCI state to specify a QCL relationship between the aperiodic CSI-RS and PDSCH. In one implementation, the network entity 104 may transmit a MAC-CE to indicate a joint or DL TCI state to specify a QCL relationship between the aperiodic CSI-RS and PDCCH.

The network entity transmits 510, to the UE, an indication for triggering an aperiodic reference signal associated with one of the plurality of TCI states. For example, referring to FIG. 3, the network entity 104 transmits 310, to the UE 102, a scheduling or triggering signaling to schedule transmission of one or more aperiodic CSI-RS. In one implementation, the network entity 104 may transmit a DCI to trigger the transmission of one or more aperiodic CSI-RS using scheduled resources that are offset in time from the DCI.

The network entity transmits 512, to the UE, the aperiodic reference signal for the UE to receive using a default beam, the default beam being selected based on a timing of the aperiodic reference signal being below a threshold. For example, referring to FIG. 3, the network entity 104 transmits 312, to the UE 102, the one or more aperiodic CSI-RS at the scheduled time. The UE 102 may determine one or more default beams to use to receive the aperiodic CSI-RS when a timing of the aperiodic CSI-RS is below a threshold. For example, the UE 102 may determine one or more default beams based on the indicated joint/DL state when the offset from the scheduling or triggering DCI is less than the beam switching time (e.g., beam switching time 207 in FIG. 2) of the UE 102. Thus, the UE 102 may determine one or more default beams to receive the aperiodic CSI-RS before the UE 102 successfully decodes the DCI and completes beam switching.

The network entity receives 516, from the UE, measurement information for the aperiodic reference signal. For example, referring to FIG. 3, the UE 102 transmit 316, to the network entity 104, a beam report containing the measurement information for the aperiodic CSI-RS.

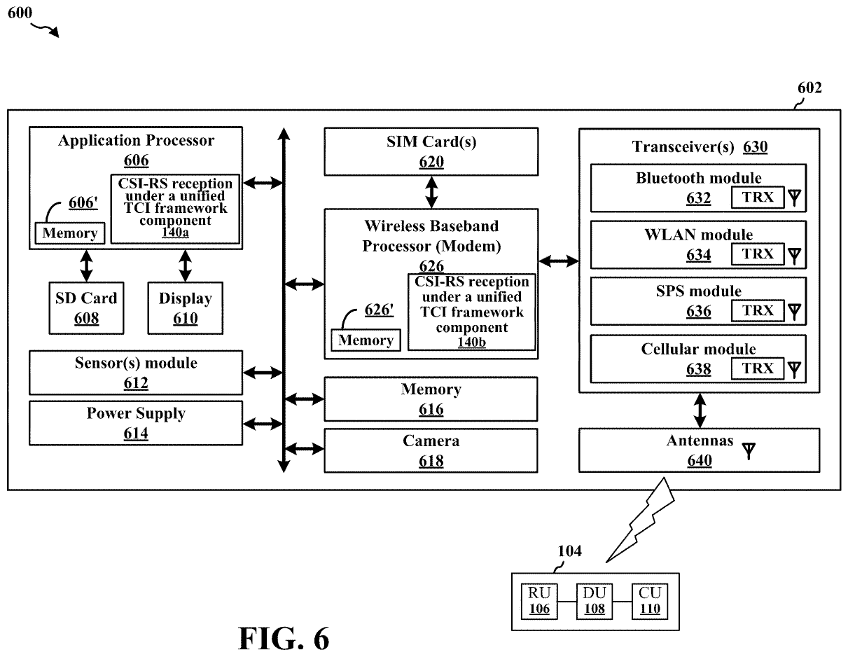

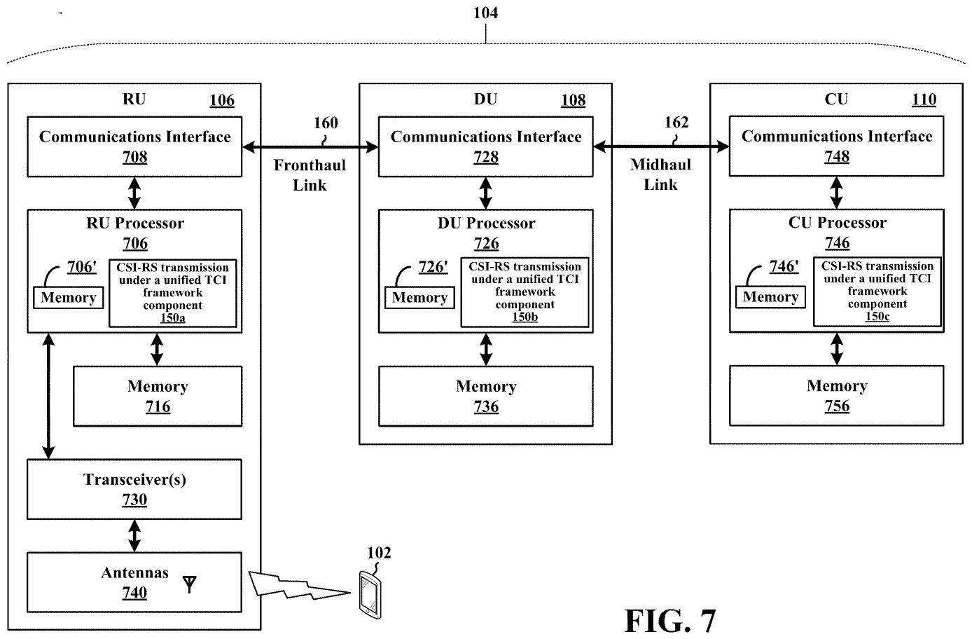

A UE apparatus 602, as described in FIG. 6, may perform the method of flowchart 400. The one or more network entities 104, as described in FIG. 7, may perform the method of flowchart 500.

FIG. 6 is a diagram 600 illustrating an example of a hardware implementation for a UE apparatus 602. The UE apparatus 602 may be the UE 102, a component of the UE 102, or may implement UE functionality. The UE apparatus 602 may include an application processor 606, which may have on-chip memory 606′. In examples, the application processor 606 may be coupled to a secure digital (SD) card 608 and/or a display 610. The application processor 606 may also be coupled to a sensor(s) module 612, a power supply 614, an additional module of memory 616, a camera 618, and/or other related components. For example, the sensor(s) module 612 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 602 may further include a wireless baseband processor 626, which may be referred to as a modem. The wireless baseband processor 626 may have on-chip memory 626′. Along with, and similar to, the application processor 606, the wireless baseband processor 626 may also be coupled to the sensor(s) module 612, the power supply 614, the additional module of memory 616, the camera 618, and/or other related components. The wireless baseband processor 626 may be additionally coupled to one or more subscriber identity module (SIM) card(s) 620 and/or one or more transceivers 630 (e.g., wireless RF transceivers).

Within the one or more transceivers 630, the UE apparatus 602 may include a Bluetooth module 632, a WLAN module 634, an SPS module 636 (e.g., GNSS module), and/or a cellular module 638. The Bluetooth module 632, the WLAN module 634, the SPS module 636, and the cellular module 638 may each include an on-chip transceiver (TRX), or in some cases, just a transmitter (TX) or just a receiver (RX). The Bluetooth module 632, the WLAN module 634, the SPS module 636, and the cellular module 638 may each include dedicated antennas and/or utilize antennas 640 for communication with one or more other nodes. For example, the UE apparatus 602 can communicate through the transceiver(s) 630 via the antennas 640 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 626 and the application processor 606 may each include a computer-readable medium/memory 626′, 606′, respectively. The additional module of memory 616 may also be considered a computer-readable medium/memory. Each computer-readable medium/memory 626′, 606′, 616 may be non-transitory. The wireless baseband processor 626 and the application processor 606 may each be responsible for general processing, including execution of software stored on the computer-readable medium/memory 626′, 606′, 616. The software, when executed by the wireless baseband processor 626/application processor 606, causes the wireless baseband processor 626/application processor 606 to perform the various functions described herein. The computer-readable medium/memory may also be used for storing data that is manipulated by the wireless baseband processor 626/application processor 606 when executing the software. The wireless baseband processor 626/application processor 606 may be a component of the UE 102. The UE apparatus 602 may be a processor chip (e.g., modem and/or application) and include just the wireless baseband processor 626 and/or the application processor 606. In other examples, the UE apparatus 602 may be the entire UE 102 and include the additional modules of the apparatus 602.

As discussed in FIG. 1 and implemented with respect to FIG. 4, the CSI-RS reception under a unified transmission configuration indicator (TCI) framework component 140 (also referred to as “CSI-RS reception component 140”) is configured to receive, from a network entity, a plurality of TCI states; receive, from the network entity, an indication for triggering an aperiodic reference signal associated with one of the plurality of TCI states; and to receive, from the network entity, the aperiodic reference signal using a default beam. The CSI-RS reception component 140 may select the default beam based on a timing of the aperiodic reference signal being below a threshold.

The CSI-RS reception component 140 may be within the application processor 606 (e.g., at 140a), the wireless baseband processor 626 (e.g., at 140b), or both the application processor 606 and the wireless baseband processor 626. The CSI-RS reception component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 7 is a diagram 700 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 746, which may have on-chip memory 746′. In some aspects, the CU 110 may further include an additional module of memory 756 and/or a communications interface 748, both of which may be coupled to the CU processor 746. The CU 110 can communicate with the DU 108 through a midhaul link 162, such as an F1 interface between the communications interface 748 of the CU 110 and a communications interface 728 of the DU 108.

The DU 108 may include a DU processor 726, which may have on-chip memory 726′. In some aspects, the DU 108 may further include an additional module of memory 736 and/or the communications interface 728, both of which may be coupled to the DU processor 726. The DU 108 can communicate with the RU 106 through a fronthaul link 160 between the communications interface 728 of the DU 108 and a communications interface 708 of the RU 106.

The RU 106 may include an RU processor 706, which may have on-chip memory 706′. In some aspects, the RU 106 may further include an additional module of memory 716, the communications interface 708, and one or more transceivers 730, all of which may be coupled to the RU processor 706. The RU 106 may further include antennas 740, which may be coupled to the one or more transceivers 730, such that the RU 106 can communicate through the one or more transceivers 730 via the antennas 740 with the UE 102.

The on-chip memory 706′, 726′, 746′ and the additional modules of memory 716, 736, 756 may each be considered a computer-readable medium/memory. Each computer-readable medium/memory may be non-transitory. Each of the processors 706, 726, 746 is responsible for general processing, including execution of software stored on the computer-readable medium/memory. The software, when executed by the corresponding processor(s) 706, 726, 746 causes the processor(s) 706, 726, 746 to perform the various functions described herein. The computer-readable medium / memory may also be used for storing data that is manipulated by the processor(s) 706, 726, 746 when executing the software. In examples, the channel correlation report configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 5, the CSI-RS transmission under a unified transmission configuration indicator (TCI) framework component 150 (also referred to as “CSI-RS transmission component 150”) is configured to transmit, to a UE, a plurality of TCI states; transmit, to the UE, an indication for triggering an aperiodic reference signal associated with one of the plurality of TCI states; and to transmit, to the UE, the aperiodic reference signal for the UE to receive using a default beam. The default beam may be selected based on a timing of the aperiodic reference signal being below a threshold.

The CSI-RS transmission component 150 may be within one or more processors of the one or more network entities 104, such as the RU processor 706 (e.g., at 150a), the DU processor 726 (e.g., at 150b), and/or the CU processor 746 (e.g., at 150c). The CSI-RS transmission component 150a-150c may be one or more hardware components specifically configured to carry out the stated processes/algorithm, implemented by one or more processors 706, 726, 746 configured to perform the stated processes/algorithm, stored within a computer-readable medium for implementation by the one or more processors 706, 726, 746, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a configuration for a plurality of transmission configuration indicator (TCI) states; receiving, from the network entity an indication for triggering an aperiodic reference signal associated with one of the plurality of TCI states; and receiving, from the network entity, the aperiodic reference signal using a default beam, the default beam being selected based on a timing of the aperiodic reference signal being below a threshold.

Example 2 may be combined with Example 1 and includes that a first TCI state of the plurality of TCI state is associated with a first transmission and reception point (TRP) identifier, and a second TCI state of the plurality of TCI states is associated with a second TRP identifier.

Example 3 may be combined with Example 2, and includes that the default beam is based on a TCI state associated with a downlink signal associated with the first TRP identifier or the second TRP identifier that is scheduled with the transmission of the aperiodic reference signal; or that the default beam is based the first TCI state or the second TCI state when a downlink signal associated with the one TRP identifier is not scheduled with the transmission of the aperiodic reference signal.

Example 4 may be combined with Examples 2 or 3, and includes that the default beam is based on the first TCI state or the second TCI state depending on an index of a symbol or a slot of the transmission of the aperiodic reference signal when a downlink signal associated with either of the first TRP identifier or the second TRP identifier is not scheduled with the transmission of the aperiodic reference signal.

Example 5 may be combined with Examples 2 or 3, and includes receiving, from the network entity, a second configuration to indicate whether the default beam is based on the first TCI state or the second TCI state when a downlink signal associated with either of the first TRP identifier or the second TRP identifier is not scheduled with the transmission of the aperiodic reference signal.

Example 6 may be combined with Examples 2 or 3, and includes that the default beam is based on both the first TCI state and the second TCI state. The indication for triggering the aperiodic reference signal indicates the first TCI state or the second TCI state as applying to an actual beam for the aperiodic reference signal when a downlink signal associated with either of the first TRP identifier or the second TRP identifier is not scheduled with the transmission of the aperiodic reference signal.

Example 7 may be combined with Examples 2 or 3, and includes that the default beam is based on a TCI state associated with receiving a second reference signal from the first TRP identifier or the second TRP identifier when a downlink signal associated with either of the first TRP identifier or the second TRP identifier is not scheduled with the transmission of the aperiodic reference signal; or that the default beam is based on a TCI state associated with receiving a second reference signal from the first TRP identifier or the second TRP identifier when the default beam is initially associated with a non-serving cell.

Example 8 may be combined with Example 1, and includes that the default beam is based on a first TCI state or a second TCI state associated with a downlink signal that is scheduled with the transmission of the aperiodic reference signal; or that the default beam is based on a first TCI state or a second TCI state when a downlink signal is not scheduled with the transmission of the aperiodic reference signal.

Example 9 may be combined with Example 8, and includes receiving, from the network entity, a second configuration to indicate a single frequency network (SFN) operation for a serving cell. The default beam is based on both a first TCI state and a second TCI state when a downlink signal is not scheduled with the transmission of the aperiodic reference signal.

Example 10 may be combined with Example 8, and includes that the default beam is based on a first TCI state or a second TCI state depending on an index of a symbol or a slot of the transmission of the aperiodic reference signal when a downlink signal is not scheduled with the transmission of the aperiodic reference signal.

Example 11 may be combined with Example 8, and includes receiving, from the network entity, a second configuration to indicate whether the default beam is based on a first TCI state or a second TCI state when a downlink signal is not scheduled with the transmission of the aperiodic reference signal.

Example 12 may be combined with Example 8, and includes that the default beam is based on both a first TCI state and a second TCI state. The indication for triggering the transmission of the aperiodic reference signal indicates the first TCI state or the second TCI state as applying to an actual beam for the aperiodic signal when a downlink signal is not scheduled with the transmission of the aperiodic reference signal.

Example 13 may be combined with Example 8, and includes that the default beam is based on a TCI state associated with receiving a second reference signal from the network entity (104) when a downlink signal is not scheduled with the transmission of the aperiodic reference signal.

Example 14 may be combined with Example 8, and includes that the default beam is based on a TCI state associated with receiving a second reference signal from the network entity when the default beam is initially associated with a non-serving cell.

Example 15 may be combined with any of Examples 1-14, and includes that the timing of the aperiodic reference signal includes a timing offset between transmission of the indication and transmission of the aperiodic reference signal.

Example 16 may be combined with Example 1, and includes receiving, from the network entity, an activation signal to apply one or more of the plurality of TCI states; or transmitting, to the network entity, measurement information for the aperiodic reference signal.

Example 17 is a method of wireless communication at a network entity, including: transmitting, to a UE, a configuration for a plurality of transmission configuration indicator (TCI) states; transmitting, to the UE, an indication for triggering an aperiodic reference signal associated with one of the plurality of TCI states; and transmitting, to the UE, the aperiodic reference signal for the UE (102) to receive using a default beam, the default beam being selected based on a timing of the aperiodic reference signal being below a threshold.

Example 18 may be combined with Example 17, and includes that a first TCI state of the plurality of TCI states is associated with a first transmission and reception point (TRP) identifier, and a second TCI state of the plurality of TCI states is associated with a second TRP identifier.

Example 19 may be combined with any Examples 17 or 18, and includes that the timing of the aperiodic reference signal includes a timing offset between transmission of the indication and transmission of the aperiodic reference signal.

Example 20 is an apparatus for wireless communication, including a memory, a transceiver, and a processor coupled to the memory and the transceiver, the apparatus being configured to implement a method as in any of Examples 1-19.

Example 21 may be combined with Example 3, and includes that the default beam is based on the first TCI state or the second TCI state when a downlink signal from either of the first TRP or the second TRP is not scheduled with the transmission of the aperiodic reference signal.

Example 22 may be combined with Example 18, and includes that the default beam is based on a TCI state associated with a downlink signal associated with one of the first TRP identifier or the second TRP identifier that is scheduled with the transmission of the aperiodic reference signal.

Example 23 may be combined with Example 18, and includes that the default beam is based on the first TCI state or the second TCI state when a downlink signal associated with the one TRP identifier is not scheduled with the transmission of the aperiodic reference signal.

Example 24 may be combined with Example 23, and includes transmitting, to the UE, a second configuration to indicate whether the default beam is based on the first TCI state or the second TCI state when a downlink signal associated with either of the first TRP identifier or the second TRP identifier is not scheduled with the transmission of the aperiodic reference signal.

Example 25 may be combined with Examples 23 or 24, and includes that the default beam is based on a TCI state associated with transmitting a second reference signal from the first TRP identifier or the second TRP identifier.

Example 26 may be combined with Example 17, and includes that the default beam is based on a first TCI state or a second TCI state associated with a downlink signal that is scheduled with the transmission of the aperiodic reference signal.

Example 27 may be combined with Example 17, and includes that the default beam is based on a first TCI state or a second TCI state when a downlink signal is not scheduled with the transmission of the aperiodic reference signal.

Example 28 may be combined with Example 27, and includes transmitting, to the UE, a second configuration to indicate a single frequency network (SFN) operation for a serving cell. The default beam is based on both a first TCI state and a second TCI state when a downlink signal is not scheduled with the transmission of the

1. A method of wireless communication at a user equipment (UE) comprising:
receiving, from a network entity, a configuration for a plurality of transmission configuration indicator (TCI) states;
receiving, from the network entity, an indication for triggering an aperiodic reference signal associated with one of the plurality of TCI states; and
receiving, from the network entity, the aperiodic reference signal using a default beam, the default beam being selected based on a timing of the aperiodic reference signal being below a threshold, whether a downlink signal is scheduled in a same symbol with a transmission of the aperiodic reference signal, and one of the plurality of TCI states when the downlink signal is not scheduled in the same symbol with the transmission of the aperiodic reference signal and a TCI state associated with the downlink signal when the downlink signal is scheduled in the same symbol with the transmission of the aperiodic reference signal.

2. The method of claim 1, wherein a first TCI state of the plurality of TCI states is associated with a first transmission and reception point (TRP) identifier, and a second TCI state of the plurality of TCI states is associated with a second TRP identifier.

3. The method of claim 2, wherein the default beam is based on:
the TCI state associated with the downlink signal associated with the first TRP identifier or the second TRP identifier that is scheduled in the same symbol with the transmission of the aperiodic reference signal; or the first TCI state or the second TCI state when the downlink signal associated with one TRP identifier is not scheduled in the same symbol with the transmission of the aperiodic reference signal.

4. The method of claim 2, wherein the default beam is based on the first TCI state or the second TCI state depending on an index of a symbol or a slot of the transmission of the aperiodic reference signal when the downlink signal associated with either of the first TRP identifier or the second TRP identifier is not scheduled with the transmission of the aperiodic reference signal.

5. The method of claim 2, further comprising:
receiving, from the network entity, a second configuration to indicate whether the default beam is based on the first TCI state or the second TCI state when the downlink signal associated with either of the first TRP identifier or the second TRP identifier is not scheduled with the transmission of the aperiodic reference signal.

6. The method of claim 2, wherein the default beam is based on both the first TCI state and the second TCI state, and wherein the indication for triggering the aperiodic reference signal indicates the first TCI state or the second TCI state as applying to an actual beam for the aperiodic reference signal when the downlink signal associated with either of the first TRP identifier or the second TRP identifier is not scheduled with the transmission of the aperiodic reference signal.

7. The method of claim2, wherein the default beam is based on:
a third TCI state associated with receiving a second reference signal from the first TRP identifier or the second TRP identifier when the downlink signal associated either of the first TRP identifier or the second TRP identifier is not scheduled with the transmission of the aperiodic reference signal; or
the third TCI state associated with receiving the second reference signal from the first TRP identifier or the second TRP identifier when the default beam is initially associated with a non-serving cell.

8. The method of claim 1, wherein the default beam is based on:
a first TCI state or a second TCI state associated with the downlink signal that is scheduled with the transmission of the aperiodic reference signal; or
the first TCI state or the second TCI state when the downlink signal is not scheduled with the transmission of the aperiodic reference signal.

9. The method of claim 8, further comprising:
receiving, from the network entity, a second configuration to indicate a single frequency network (SFN) operation for a serving cell,
wherein the default beam is based on both the first TCI state and the second TCI state when the downlink signal is not scheduled with the transmission of the aperiodic reference signal.

10. The method of claim 8, wherein the default beam is based on the first TCI state or the second TCI state depending on an index of a symbol or a slot of the transmission of the aperiodic reference signal when the downlink signal is not scheduled with the transmission of the aperiodic reference signal.

11. The method of claim 8, further comprising:
receiving, from the network entity, a second configuration to indicate whether the default beam is based on the first TCI state or the second TCI state when the downlink signal is not scheduled with the transmission of the aperiodic reference signal.

12. The method of claim 8, wherein the default beam is based on both the first TCI state and the second TCI state, and wherein the indication for triggering the transmission of the aperiodic reference signal indicates the first TCI state or the second TCI state as applying to an actual beam for the aperiodic reference signal when the downlink signal is not scheduled with the transmission of the aperiodic reference signal.

13. The method of claim 8, wherein the default beam is based on a third TCI state associated with receiving a second reference signal from the network entity when the downlink signal is not scheduled with the transmission of the aperiodic reference signal.

14. The method of claim 8, wherein the default beam is based on a third TCI state associated with receiving a second reference signal from the network entity when the default beam is initially associated with a non-serving cell.

15. The method of claim 1, wherein the timing of the aperiodic reference signal includes a timing offset between the transmission of the indication and the transmission of the aperiodic reference signal.

16. The method of claim 1, further comprising:
receiving, from the network entity, an activation signal to apply one or more of the plurality of TCI states; or
transmitting, to the network entity, measurement information for the aperiodic reference signal.

17. A method of wireless communication at a network entity, comprising:
transmitting, to a user equipment (UE) a configuration for a plurality of transmission configuration indicator (TCI) states;
transmitting to the UE, an indication for triggering an aperiodic reference signal associated with one of the plurality of TCI states; and
transmitting, to the UE, the aperiodic reference signal for the UE to receive using a default beam, the default beam being selected based on a timing of the aperiodic reference signal being below a threshold, whether a downlink signal is scheduled in a same symbol with a transmission of the aperiodic reference signal, and one of the plurality of TCI states when the downlink signal is not scheduled in the same symbol with the transmission of the aperiodic reference signal and a TCI state associated with the downlink signal when the downlink signal is scheduled in the same symbol with the transmission of the aperiodic reference signal.

18. The method of claim 17, wherein a first TCI state of the plurality of TCI states is associated with a first transmission and reception point (TRP) identifier, and a second TCI state of the plurality of TCI states is associated with a second TRP identifier.

19. The method of claim 17, wherein the timing of the aperiodic reference signal includes a timing offset between the transmission of the indication and the transmission of the aperiodic reference signal.

20. An apparatus for wireless communication at a user equipment (UE), comprising:
a memory;
a transceiver; and
a processor coupled to the memory and the transceiver, the processor being configured to;
receive, from a network entity, a configuration for a plurality of transmission configuration indicator (TCI) states,
receive, from the network entity, an indication for triggering an aperiodic reference signal associated with one of the plurality of TCI states, and
receive, from the network entity, the aperiodic reference signal using a default beam, the default beam being selected based on a timing of the aperiodic reference signal being below a threshold, whether a downlink signal is scheduled in a same symbol with a transmission of the aperiodic reference signal, and one of the plurality of TCI states when the downlink signal is not scheduled in the same symbol with the transmission of the aperiodic reference signal and a TCI state associated with the downlink signal when the downlink signal is scheduled in the same symbol with the transmission of the aperiodic reference signal.
